(19) United States
(12) Patent Application Publication
(10) Pub. No.: US 2022/0046435 A1
(43) Pub. Date: Feb. 10, 2022

(54) NETWORK COVERAGE ENHANCEMENT (CE) FOR VEHICLES

(71) Applicant: Telefonaktiebolaget LM Ericsson (publ), Stockholm (SE)

(72) Inventors: Stefan RUNESON, Lund (SE); Johan BERGMAN, Stockholm (SE); Anders K ERIKSSON, Uppsala (SE); Tomas NYLANDER, Värmdö (SE)

(73) Assignee: Telefonaktiebolaget LM Ericsson (publ), Stockholm (SE)

(21) Appl. No.: 17/433,326

(22) PCT Filed: Feb. 12, 2020
(86) PCT No.: PCT/SE2020/050154

§ 371 Date: Aug. 24, 2021

Related U.S. Application Data
(60) Provisional application No. 62/809,999, filed on Feb. 25, 2019.

(51) Int. Cl. H04W 24/02; H04W 4/40; H04W 8/24; H04W 60/06

(52) U.S. Cl. CPC H04W 24/02; H04W 60/06; H04W 8/24; H04W 4/40

(57) ABSTRACT

A method for providing enhanced network coverage for a vehicle equipped with a wireless communication device. The method includes transmitting to a mobile network a capability message indicating that the WCD does not support any coverage enhancement (CE) mode. The method also includes determining whether a condition is satisfied, which comprises determining whether the vehicle is parked. The method further includes as a result of determining that the condition is satisfied, informing the mobile network that the WCD supports a CE mode.

### TECHNICAL FIELD

Disclosed are embodiments related to network coverage enhancement (CE) for vehicles.

### BACKGROUND

Today many vehicles are equipped with a wireless communication device (WCD) (also referred to as a “user equipment (UE)”) that can connect to one or more information service providers via a cellular network provided by Mobile Network Operators (MNOs). Such vehicles are referred to herein as “connected” vehicles. Typically, the primary information service provider for a given connected vehicle is the Original Equipment Manufacturer (OEM) of the vehicle. An OEM may offer a variety of information services to the vehicle owner, such as, for example, “telematics” services, navigation services, infotainment services, software update services, traffic safety services, etc.

When a connected vehicle is in motion (e.g., being driven on a road), many of these services are active. In this case, the vehicle's wireless communication requirements are similar to those of a smartphone. The wireless communication device in the vehicle typically has a modem with high UE category (like a smartphone), providing high communication throughput to the vehicle.

On the other hand, when the connected vehicle is parked, very few services are active. In this case, the vehicle's wireless communication requirements are similar to those of a Massive Machine-type-Communication (MTC) device. A Massive MTC device has typically a completely different UE category, e.g. LTE Cat-M1 or NB-IoT, than a smartphone. The services that are active when the vehicle is parked typically send and/or receive only short messages with low frequency. Examples of such services are start of vehicle heating and update of battery status in the vehicle.

### SUMMARY

Certain challenges exist. As one example, when the connected vehicle is parked in an area outside normal cellular network coverage (e.g. in an underground garage), the connected vehicle would benefit from Coverage Enhancements (CE). 3GPP has standardized coverage enhancement techniques called CE Mode A and CE Mode B, primarily based on repetition of information transmission. CE Mode A is mandatory to support for an LTE Cat-M1/M2 UE and optional for a UE with a higher UE category. One way to provide CE to a connected vehicle is to install in the vehicle two WCDs (e.g., two modems). One WCD with high UE category to be used while the vehicle is driving, and one Massive MTC WCD (e.g. LTE Cat-M1) to be used while the vehicle is parked in an area outside normal cellular coverage. A problem with this solution is the cost and complexity of having dual WCDs and administrating dual SIMs in the vehicle or possible functionality to share one SIM between two WCDs.

Another existing solution is to use only one WCD with high UE category and support CE Mode in this WCD. The problem with this solution is that CE Mode with repetitions consumes a lot of scarce radio resources. MNOs are not likely to be willing to use CE Mode for any kind of WCD in any location and in any state.

This disclosure provides systems and methods for overcoming the above problems. In one embodiment, the problems are overcome by equipping a vehicle with a WCD (hereafter “modem”) having a high UE category and that is operable to dynamically exposes its support for CE Mode. In one embodiment, the modem exposes its support for CE Mode only when the vehicle is parked in an area where network coverage is weak (e.g. in a parking structure). A modem exposes its support for CE Mode in its “UE capabilities.” The UE capabilities are uploaded to an access node (e.g., a base station) and core network node (e.g., a 4G Mobility Management Entity (MME) or a 5G Access and Mobility Management Function (AMF)). The access node uses CE Mode only for a modem that exposes support for CE Mode in its UE capabilities.

In one example embodiment, the vehicle (e.g., an app running on processing circuitry included in the vehicle) performs following procedure: detect that the vehicle is parked; detach from the network; change the modem's support for CE Mode in its UE capabilities; and then re-attach to the network. In another example embodiment, the vehicle performs the following procedure: detect that the vehicle is parked; change the modem's support for CE Mode in its UE capabilities; and update the access node (e.g., 4G base station (eNB)) and core network node (e.g., MME) using a new “Update UE Capabilities” procedure.

More generally, there is provided a method for providing enhanced network coverage for a vehicle equipped with a wireless communication device (WCD). The method includes transmitting to a mobile network a capability message indicating that the WCD does not support any coverage enhancement (CE) mode. The method also includes determining whether a condition is satisfied, which comprises determining whether the vehicle is parked. The method further includes as a result of determining that the condition is satisfied, informing the mobile network that the WCD supports a CE mode.

In some embodiments, the capability message is an RRC message destined for a base station of the mobile network, or the capability message is a Non-Access Stratum, NAS, message destined for a control plane, CP, node of the mobile network.

In some embodiments, determining whether the condition is satisfied further comprises determining whether the vehicle is located in an area with poor network coverage. In some embodiments, determining whether the vehicle is located in an area with poor network coverage comprises determining a received signal strength of a signal transmitted by a base station and determining whether the received signal strength is less than a threshold. In some embodiments, determining whether the vehicle is located in an area with poor network coverage comprises determining that a server has not responded to a message within a threshold amount of time.

In some embodiments, the condition is satisfied when the vehicle is parked and the vehicle is located in an area with poor network coverage.

In some embodiments, the step of determining whether the condition is satisfied is performed by an app running on processing circuitry within the vehicle. In some embodiments, informing the mobile network that the WCD supports a CE mode comprises triggering the WCD to transmit to the mobile network a capability message (e.g., Update UE Capabilities message) comprising information specifying that WCD supports a CE mode. In some embodiments, informing the mobile network that the WCD supports the CE mode further comprises the app enabling the WCD to support the CE mode as a result of the app determining that the condition is satisfied and prior to triggering the WCD to transmit the capability message to the mobile network.

In some embodiments, informing the mobile network that the WCD supports a CE mode comprises: enabling support of the CE mode in the WCD; and triggering the WCD to re-register to mobile network. In some embodiments, informing the mobile network that the WCD supports a CE mode further comprises the app, prior to triggering the WCD to re-register with the mobile network, triggering the WCD to de-register with the mobile network.

In some embodiments, determining whether the condition is satisfied further comprises the app determining whether the app is able to communicate with a server, wherein the condition is satisfied when the app determines that it is not able to communicate with the server and the app determines that the vehicle is parked. In some embodiments, the process further includes the app triggering the WCD to inform the mobile network that the WCD supports a CE mode as a result of the app determining that the condition is satisfied. In some embodiments, triggering the WCD to inform the mobile network that the WCD supports a CE mode comprises the app using AT-Command or an application programming interface (API) to send a control plane, CP, message to the WCD.

In some embodiments, the process further includes determining that the condition is no longer satisfied; and as a result of determining that the condition is no longer satisfied, informing the mobile network that the WCD does not support any CE mode.

In some embodiments, the WCD is located on or in the vehicle.

In another aspect there is provided a wireless communication device (WCD) that is adapted to perform any of the method disclosed herein. In another aspect there is provided a vehicle comprising the WCD.

In another aspect there is provided a computer program comprising instructions which when executed by processing circuitry causes the processing circuitry to perform any of the method described herein. In another aspect there is provided a carrier containing the computer program, wherein the carrier is one of an electronic signal, an optical signal, a radio signal, and a computer readable storage medium.

The embodiments have the following advantages: 1) reducing cost and complexity by having only one single modem and one single SIM in the vehicle and 2) scarce radio resources for CE Mode will be used only when a vehicle is parked (e.g. parked in an area outside normal cellular coverage).

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 illustrates a vehicle going from a driving state to a parking state.

FIG. 3 is a message flow diagram illustrating an embodiment.

FIG. 4 is a message flow diagram illustrating an embodiment.

FIG. 5 is a message flow diagram illustrating an embodiment.

FIG. 6 is a message flow diagram illustrating an embodiment.

FIG. 7 is a message flow diagram illustrating an attach procedure.

FIG. 8 is a flow chart illustrating an embodiment.

FIG. 9 is a block diagram illustrating some components of the vehicle.

### DETAILED DESCRIPTION

As used herein “CE Mode” encompasses CE Mode A and/or CE Mode B (which are specified in the 3GPP LTE standard) as well as any coverage enhancement functionality in some other radio access technology, for example 3GPP NR.

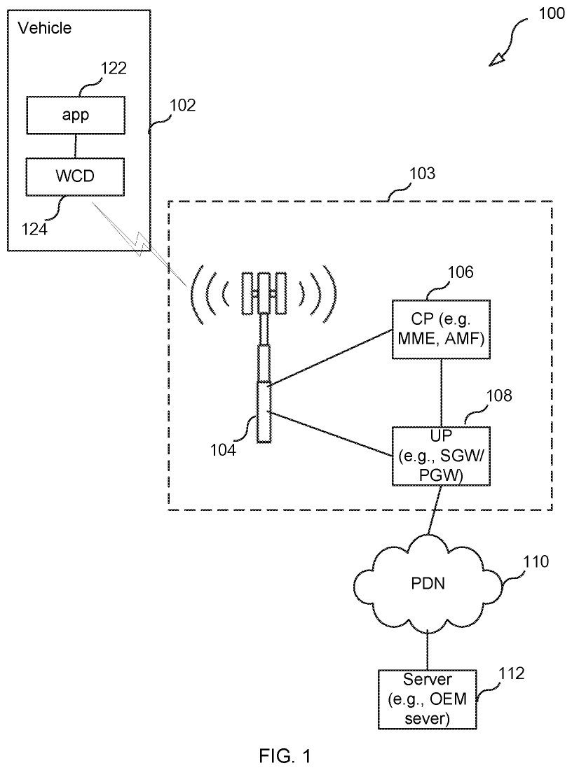

FIG. 1 illustrates a system 100 according to an embodiment. As illustrated in FIG. 1, a vehicle 102 is equipped with a WCD 124 capable of wireless communicating with a base station (e.g., eNB) 104 of a mobile network 103. Vehicle 102 also includes an application (app) 122 for communicating, via WCD 124 and network 103, with a remote server 112 (e.g., an OEM server) connected to a network 110 (e.g., a packet data network (PDN) such as the Internet) that is connected to mobile network 103. In the embodiment shown in FIG. 1 app 122 is separate from WCD 124, but in other embodiments app 122 may run on processing circuitry of WCD 124. Mobile network 103 includes a control plane (CP) 106 that includes one more control plane nodes, such as, for example, a 4G MME, a 5G SMF, a 5G AMF. Mobile network 103 also includes a user plane (UP) 108 that includes one or more user plane nodes, such as, for example, a 5G User Plane Function (UPF), a 4G serving gateway (SGW), and a 4G PDN gateway (PGW).

In some embodiments, app 122 sends control plane (CP) messages to WCD 124 using AT-Commands or an application program interface (API); app 122 sends/receives user plane (UP) messages to/from server 112 using an application layer protocol (e.g., HTTP or a propriety an OEM protocol); WCD 124 can send CP messages to and receive CP messages from base station 104 using the Radio Resource Control (RRC) protocol; and WCD 124 can send CP messages to and receive CP messages from CP 106 using the Non-Access Stratum (NAS) protocol.

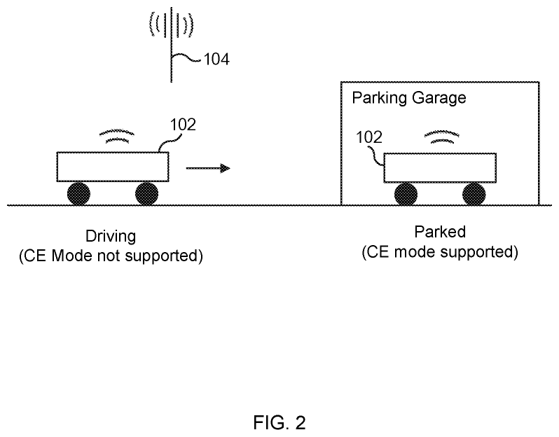

FIG. 2 illustrates vehicle 102 going from i) a moving state in which WCD 124 has a strong signal from base station 104 to ii) a parked state in which WCD 124 has a poor network coverage (e.g., WCD 124 is in a location in which the received signal strength of a signal (or the average received signal strength of signals) transmitted by a serving base station 104 is below a threshold). When WCD 124 has poor network coverage, app 122 is typically unable to communicate with a server attached to a public data network (e.g., the Internet)) due to the poor connection between WCD 124 and base station 104. As noted above, when the vehicle 102 is in a parked state with poor network coverage, it is advantageous for WCD 124 to inform the network 103 that WCD 124 supports a CE mode (e.g., CE Mode A, CE Mode B, and/or other CE mode).

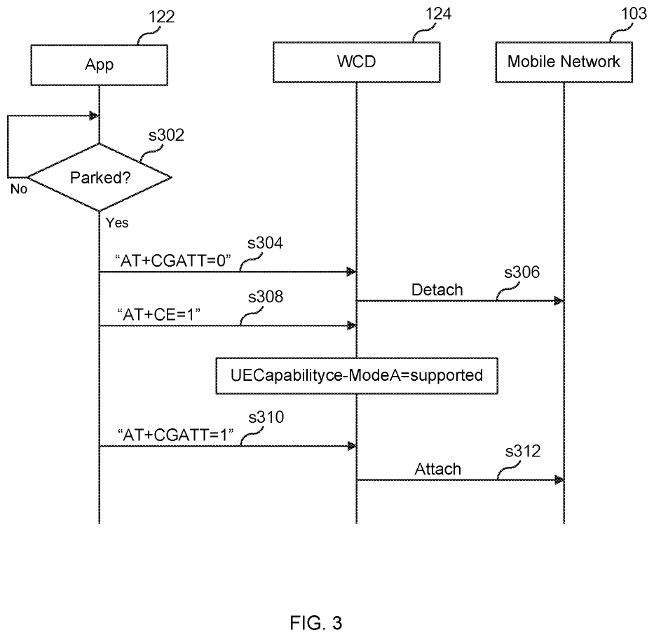

FIG. 3 is a message flow diagram illustrating a method, according to one embodiment, for dynamic update of WCD capabilities. This embodiment assumes that WCD 124 has previously registered (e.g., attached) with mobile network 103 and as part of the registration (e.g., attachment) informed mobile network 103 (e.g., base station 104 and or CP node 106) that WCD 124 does not support any CE mode. As shown in FIG. 3, app 122 may periodically determine whether vehicle 102 is parked (step s302). App 122 may detect that vehicle 102 is parked based on information from sensors in vehicle, e.g. ignition off, no passenger in the car and doors locked from outside.

In response to determining that vehicle 102 is parked, app 122 instructs WCD 124 to de-register from (e.g., detach from) the mobile network 103 by, for example, sending to WCD 124 a “detach” command, e.g., an AT command or other type of API (step s304). In response to the detach command, WCD 124 sends a detach message to mobile network 103 (step s306) (e.g., WCD 124 sends to CP 106 a NAS Detach Request message). Next, app 122 enables WCD 124 to support a CE Mode via, for example, an AT command or other type of API (step s308). Next, app 122 asks WCD 124 to re-register (e.g., re-attach) to mobile network 103 by sending to WCD 124 a “re-attach” command (e.g., an AT command or other type of API message) (step s310). In response to the re-attach command, WCD 124 re-registers with mobile network 103 and informs mobile network that WCD 124 is enabled for (i.e. supports) a CE mode (e.g. CE-ModeA).

For example, in one embodiment, in step s312 WCD 124 performs a standard 4G attach procedure, which includes network 103 sending to WCD 124 a message (e.g. UE Capability inquiry) requesting that WCD 124 provide to network 103 capability information indicating WCD 124's capabilities, which WCD 124 responds to by sending to network 103 the requested capability information, which in this case will indicate that WCD 124 supports a CE mode (e.g., ce-ModeA and/or ce-ModeB).

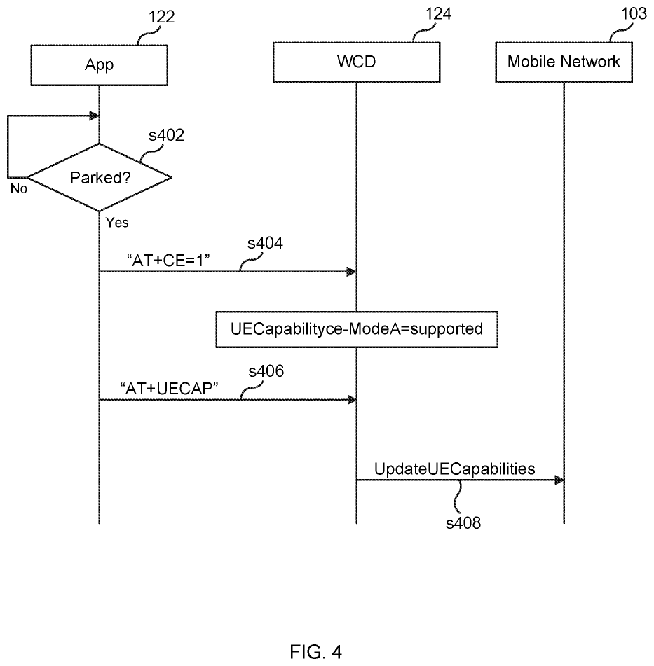

FIG. 4 is a message flow diagram illustrating a method, according to another embodiment, for dynamic update of WCD capabilities. This embodiment assumes that WCD 124 has previously registered (e.g., attached) with mobile network 103 and as part of the registration (e.g., attachment) informed mobile network 103 (e.g., base station 104 and or CP node 106) that WCD 124 does not support any CE mode. As shown in FIG. 4, app 122 may periodically determine whether vehicle 102 is parked (step s402). In response to determining that vehicle 102 is parked, app 122 enables support for CE Mode in UE capabilities in WCD 124 via an AT command or other type of API (step s404). Next, via an AT command or other type of API, app 122 asks WCD 124 to update mobile network 103 (e.g., eNB 104 and/or MME 106) using a new procedure “Update UE Capabilities” (step s406). In response to the request from app 122 to update mobile network 103, WCD 124 transmits to mobile network 103 a capability message (e.g., UpdateUECapabilities message) comprising information specifying that WCD 124 supports a CE mode (step s408). In one embodiment, the capability message is a NAS message that processed by CP 106, in which case CP 106 sends to base station 104 a message specifying that WCD 124 supports the CE mode specified in the NAS message. In another embodiment, the capability message is an RRC message from WCD 124 to base station 104, in which case base station 104 transmits to CP 106 a message specifying that WCD 124 supports the CE mode specified in the RRC message.

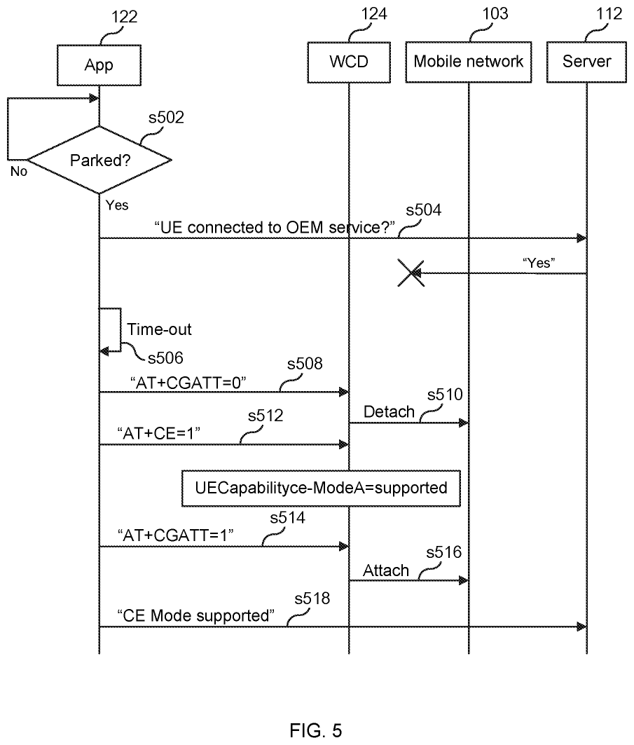

FIG. 5 is a message flow diagram illustrating a method, according to another embodiment, for dynamic update of WCD capabilities. This embodiment assumes that WCD 124 has previously registered (e.g., attached) with mobile network 103 and as part of the registration (e.g., attachment) informed mobile network 103 (e.g., base station 104 and or CP node 106) that WCD 124 does not support any CE mode.

As shown in FIG. 5, app 122 may periodically determine whether vehicle 102 is parked (step s502) and is in a poor coverage area. If vehicle 102 is parked in an area inside normal coverage, the app 122 shall not enable support for CE Mode in WCD 124.

To detect whether vehicle 102 is inside normal cellular coverage or not, app 122 may check its connection to server 112 (step s504). If app 122 has connection to the server 112, the conclusion is that the vehicle is parked in an area inside normal coverage. In this case, app 122 shall not enable support for CE Mode in WCD 124.

In one embodiments, app 122 checks its connection to server 112 by sending to server, via WCD 124 and mobile network 103, a message (e.g., a “hello” message) (step s504) and then waiting to see whether or not a response (e.g., “Yes”) transmitted by server 112 is received at WCD 124. If no response is received within a certain amount of time from when the hello message was sent in step s504, then app 112 will detect a time out condition (step s506) and determine that vehicle is not in a normal coverage area. An alternative way for app 122 to determine whether or not vehicle 102 is inside normal cellular coverage, is for app 122 to query WCD 124 for information regarding the strength of signals transmitted by base station 104. In another embodiment, app 122 may become aware that vehicle is not inside normal network coverage by receiving a notification provided by WCD 124, which can detect whether it is inside normal network coverage by measuring the strength of a signal (e.g., a reference signal) transmitted by base station 104.

When vehicle 102 is parked in an area outside normal coverage and CE Mode is enabled in WCD 124, only services that send short messages with low frequency shall be active. Since these messages may be sent by both app 122 and the OEM Service, both endpoints have to be aware of whether CE Mode is enabled in the UE. When app 122 has enabled support for CE Mode in WCD 124, app 122 sends a message to the OEM Server notifying the OEM Server that CE Mode is supported in WCD 124.

In one embodiment, as a result of determining vehicle 102 is parked and not in a normal coverage area (e.g., detecting the time out condition), app 122 instructs WCD 124 to de-register from (e.g., detach from) the mobile network 103 by sending to WCD 124 a “detach” command, e.g., an AT command or other type of API (step s508); and in response to the detach command, WCD 124 sends a detach message to mobile network 103 (step s510) (e.g., WCD 124 sends to CP 106 a NAS Detach Request message). In other embodiments, steps s508 and s510 are not preformed because, at the time app 122 determines that vehicle 102 is parked and not in a normal coverage area, WCD 124 may already be detached from mobile network 103.

In step s512, app 122 enables WCD 124 to support CE Mode (e.g., via an AT command or other type of API). Next, app 122 asks WCD 124 to re-register (e.g., re-attach) to mobile network 103 by sending to WCD 124 a “re-attach” command (e.g., an AT command or other type of API message) (step s514). In response to the re-attach command, WCD 124 re-registers with mobile network 103 and informs mobile network that WCD 124 is enabled for (i.e. supports) a CE mode (e.g. CE-ModeA) (step s516). In step s518, app 122 sends a message to server 112 notifying server 112 that WCD 124 supports a CE Mode.

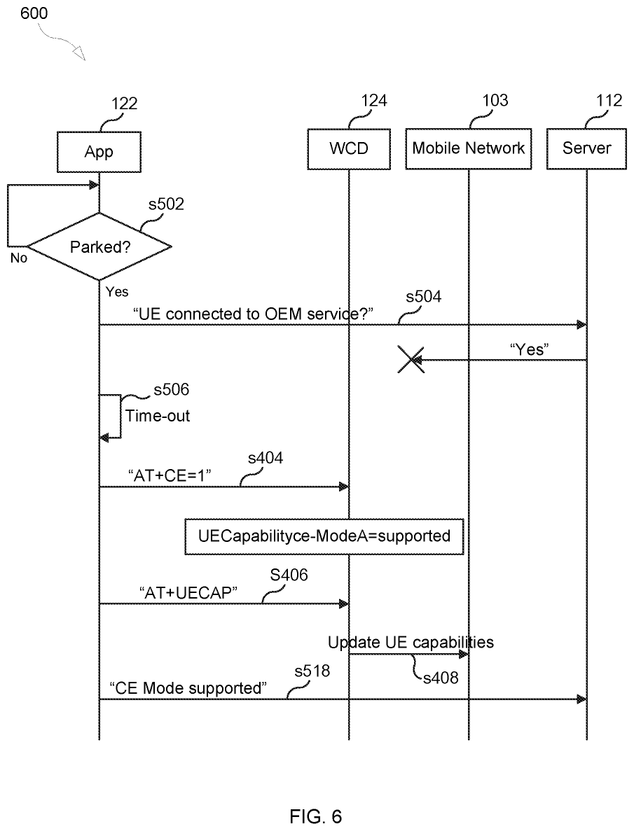

FIG. 6 is a message flow diagram illustrating a method, according to another embodiment, for dynamic update of WCD capabilities. This embodiment assumes that WCD 124 has previously registered (e.g., attached) with mobile network 103 and as part of the registration (e.g., attachment) informed mobile network 103 (e.g., base station 104 and or CP node 106) that WCD 124 does not support any CE mode. As shown in FIG. 6, app 122 performs steps s502, s504, and s506, as discussed above with respect to FIG. 5. In this embodiment, in response to determining that vehicle 102 is parked and app 122 is not able to communicate with server 112, app 122 performs steps s404 and s406 described above and WCD 124 performs step s408 described above. Lastly, after WCD has performed step s408, app 122 performs step s518 described above.

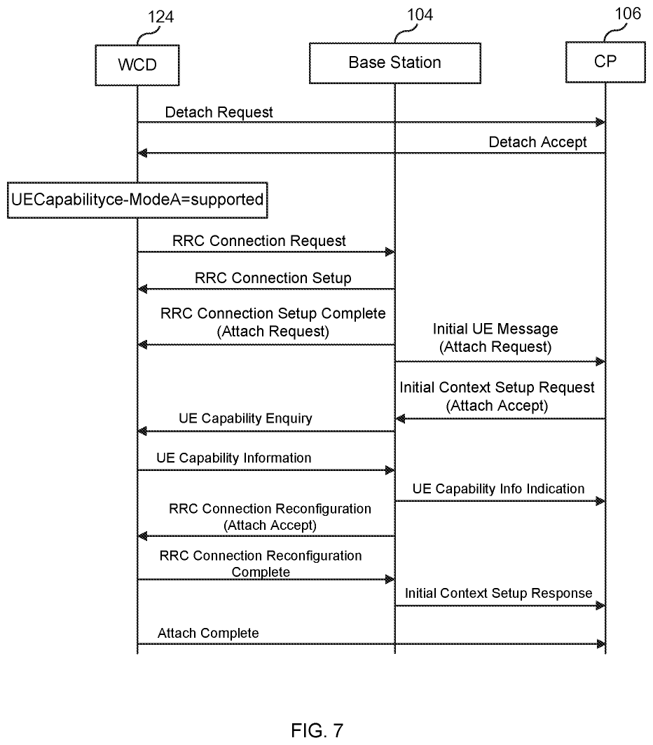

FIG. 7 illustrates a conventional 4G detach and attach procedure between WCD 124, base station 104 and CP 106.

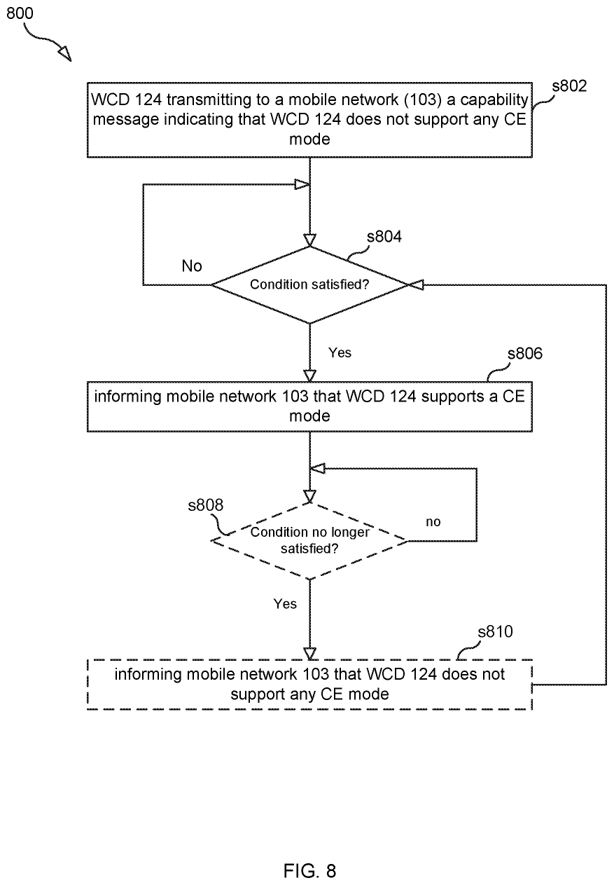

FIG. 8 is a flow chart illustrating a process 800, according to an embodiment, that is performed by vehicle 102. Process 800 may start with step s802.

Step s802 comprises WCD 124 transmitting to mobile network 103 a capability message comprising information indicating that WCD 124 does not support any CE mode. For example, the capability message may not include any parameter specifying that WCD 124 supports a CE mode, thereby comprising information indicating that WCD 124 does not support any CE mode. In some embodiments, the capability message is an RRC message, and in other embodiments it is a NAS message.

Step s804 comprises vehicle 102 (e.g. app 122) determining whether a condition is satisfied, which comprises determining whether vehicle 102 is parked. In some embodiments, step s804 also comprises determining whether vehicle is located in an area with poor network coverage (e.g., an area in which the signal strength of a signal (or the average signal strength of signals) transmitted by base station 104 is below a threshold). In some embodiments, the condition is satisfied when vehicle 102 is parked and vehicle is located in an area with poor network coverage. In some embodiments, determining whether the vehicle 102 is located in an area with poor network coverage comprises determining a received signal strength of a signal transmitted by base station 104 serving the WCD 124 and determining whether the received signal strength is less than a threshold.

Steps s806 comprises vehicle 102, as a result of determining that the condition is satisfied, informing mobile network 103 that WCD 124 supports a CE mode.

In some embodiments, vehicle 102 informs mobile network 103 that WCD 124 supports a CE mode by triggering WCD 124 to transmit to mobile network 103 a capability message (e.g., Update UE Capabilities message) comprising information specifying that WCD 124 supports a CE mode.

In some embodiments, vehicle 102 informs mobile network 103 that WCD 124 supports a CE mode by: 1) triggering WCD 124 to de-register (e.g., detach) from mobile network 103, 2) enabling support of a CE mode in WCD 124, and 3) triggering WCD 124 to re-register (e.g., Re-Attach) to mobile network 103. In some embodiments, as a result of enabling support of the CE mode in WCD 124, WCD 124 will respond to a UE Capability Enquiry transmitted by mobile network 103 as part of an Attach procedure (see FIG. 7, which illustrates the Attach procedure) by transmitting to mobile network 103 a UE Capability Information message comprising information specifying that WCD 124 supports a CE mode.

In some embodiments, process 800 further includes steps s808 and s810. In step s808, vehicle 102 determines whether the condition is no longer satisfied. If the condition is no longer satisfied, then vehicle 102 may perform step s810, which vehicle 102 informs mobile network 103 that WCD 124 does not support any CE mode. For example, in step s810, vehicle 102 informs mobile network 103 that WCD 124 does not support any CE mode by: 1) triggering WCD 124 to detach from mobile network 103, 2) disabling support of a CE mode in WCD 124, and 3) triggering WCD 124 to re-attach to mobile network 103. In another embodiment, vehicle 102 informs mobile network 103 that WCD 124 does not support any CE mode by triggering WCD 124 to send to mobile network 103 a capability message indicating that WCD 124 does not support any CE mode.

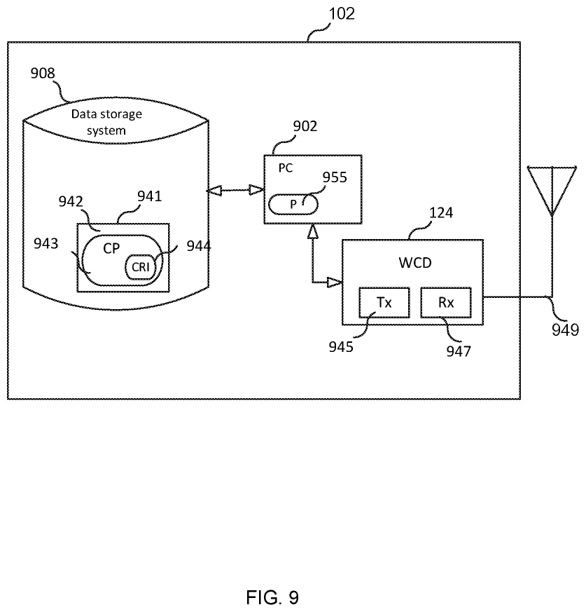

FIG. 9 is a block diagram showing some components of vehicle 102, according to some embodiments. As shown in FIG. 9, vehicle 102 may comprise: processing circuitry (PC) 902, which may include one or more processors (P) 955 (e.g., a general purpose microprocessor and/or one or more other processors, such as an application specific integrated circuit (ASIC), field-programmable gate arrays (FPGAs), and the like); WCD 124, which comprises a transmitter (Tx) 945 and a receiver (Rx) 947 coupled to antenna arrangement 949 (e.g., an arrangement of one or more antennas) for enabling WCD 124 to wirelessly transmit data to and wirelessly receive data from base station 104; and a local storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 (e.g., app 122) comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes vehicle 102 to perform steps described herein (e.g., steps described herein with reference to any of the flowcharts). In other embodiments, vehicle 102 may be configured to perform steps described herein without the need for code. That is, for example, PC 902 may consist merely of one or more ASICs. Hence, the features of the embodiments described herein may be implemented in hardware and/or software.

### Summary of Various Embodiments

PA1. A method performed by a vehicle (102) comprising a wireless communication device, WCD (124) (e.g. a modem), the method comprising: transmitting (s802) to a mobile network (103) a capability message indicating that the WCD does not support any CE mode; determining (s804) whether a condition is satisfied, which comprises determining whether the vehicle is parked; and as a result of determining that the condition is satisfied, informing (s806) the mobile network (103) that the WCD (124) supports a CE mode.

PA2. The method of embodiment PA1, wherein the capability message is an RRC message destined for a base station (104) of the mobile network (103), or the capability message is a Non-Access Stratum, NAS, message destined for a control plane, CP, node (e.g., an MME or AMF) of the mobile network (103).

PA3. The method of embodiment PA1 or PA2, wherein determining whether the condition is satisfied further comprises determining whether the vehicle (102) is located in an area with poor network coverage.

PA4. The method of embodiment PA3, wherein determining whether the vehicle (102) is located in an area with poor network coverage comprises determining a received signal strength of a signal transmitted by a base station serving the WCD (124) and determining whether the received signal strength is less than a threshold.

PA5. The method of embodiment PA3 or PA4, wherein the condition is satisfied when the vehicle (102) is parked and the vehicle (102) is located in an area with poor network coverage.

PA6. The method of any one of embodiments PA1 to PA5, wherein the step of determining whether the condition is satisfied is performed by an app (122) running on processing circuitry (902) within the vehicle.

PA7. The method of any one of embodiments PA1-PA6, wherein informing the mobile network (103) that the WCD (124) supports a CE mode comprises triggering the WCD to transmit to the mobile network a capability message (e.g., Update UE Capabilities message) comprising information specifying that WCD supports a CE mode.

PA8. The method of embodiment PA7, wherein informing the mobile network (103) that the WCD (124) supports the CE mode further comprises the app (122) enabling the WCD to support the CE mode as a result of the app (122) determining that the condition is satisfied and prior to triggering the WCD to transmit the capability message to the mobile network.

PA9. The method of any one of embodiments PA1-PA6, wherein informing the mobile network (103) that the WCD (124) supports a CE mode comprises: enabling support of the CE mode in the WCD; and triggering the WCD to re-register (e.g., Re-Attach) to mobile network (103).

PA10. The method of embodiment PA9, wherein informing the mobile network (103) that the WCD (124) supports a CE mode further comprises the app (122), prior to triggering the WCD (124) to re-register with the mobile network (103), triggering the WCD (124) to de-register with the mobile network (103) (e.g., Detach from the network).

PA11. The method of any one of embodiments PA1 to PA10, further comprising: determining that the condition is no longer satisfied; and as a result of determining that the condition is no longer satisfied, informing (s810) the mobile network (103) that the WCD (124) does not support any CE mode.

PB1. A vehicle (102) comprising a wireless communication device, WCD (124) (e.g. a modem), the vehicle being adapted to: employ the WCD (12) to transmit (s802) to a mobile network (103) a capability message indicating that the WCD does not support any CE mode; determine (s804) whether a condition is satisfied, which comprises determining whether the vehicle is parked; and as a result of determining that the condition is satisfied, inform (s806) the mobile network (103) that the WCD (124) supports a CE mode.

PB2. The vehicle of embodiment B1, wherein the vehicle is adapted to perform the method of any one of embodiments A2-A11.

PC1. A computer program comprising instructions for adapting a vehicle (102) to perform the method of any one of embodiment PA1 to A11.

PC2. A carrier containing the computer program of embodiment C1, wherein the carrier is one of an electronic signal, optical signal, radio signal, or compute readable storage medium.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### Abbreviations

AMF Access and Mobility Management Function

API Application Programming Interface

CE Coverage Enhancement

eNB eNodeB

MME Mobility Management Entity

MTC Machine Type Communication

NAS Non-Access Stratum

PGW PDN Gateway

RRC Radio Resource Control

SGW Serving Gateway

SMF Session Management Function

UE User Equipment

1. A method for providing enhanced network coverage for a vehicle that is equipped with a wireless communication device, WCD (WCD), the method comprising:
transmitting to a mobile network a capability message indicating that the WCD does not support any coverage enhancement (CE) mode;
determining whether a condition is satisfied, wherein determining whether the condition is satisfied which comprises determining whether the vehicle is parked; and
as a result of determining that the condition is satisfied, informing the mobile network that the WCD supports a CE mode.

2. The method of claim 1, wherein
the capability message is an RRC a Radio Resource Control (RRC) message destined for a base station of the mobile network, or
the capability message is a Non-Access Stratum (NAS) message destined for a control plane (CP) node of the mobile network.

3. The method of claim 1, wherein determining whether the condition is satisfied further comprises determining whether the vehicle is located in an area with poor network coverage.

4. The method of claim 3, wherein determining whether the vehicle is located in an area with poor network coverage comprises determining a received signal strength of a signal transmitted by a base station and determining whether the received signal strength is less than a threshold.

5. The method of claim 3, wherein the condition is satisfied when the vehicle is parked and the vehicle is located in an area with poor network coverage.

6. The method of claim 1, wherein the step of determining whether the condition is satisfied is performed by an app (122) running on processing circuitry within the vehicle.

7. The method of claim 1, wherein informing the mobile network that the WCD supports a CE mode comprises triggering the WCD to transmit to the mobile network a capability message comprising information specifying that WCD supports a CE mode.

8. The method of claim 7, wherein informing the mobile network that the WCD supports the CE mode further comprises the app enabling the WCD to support the CE mode as a result of the app determining that the condition is satisfied and prior to triggering the WCD to transmit the capability message to the mobile network.

9. The method of claim 1, wherein informing the mobile network that the WCD supports a CE mode comprises:
enabling support of the CE mode in the WCD; and
triggering the WCD to re-register to mobile network.

10. The method of claim 9, wherein informing the mobile network that the WCD supports a CE mode further comprises the app, prior to triggering the WCD to re-register with the mobile network, triggering the WCD to de-register with the mobile network.

11. The method of claim 6, wherein determining whether the condition is satisfied further comprises the app determining whether the app is able to communicate with a server, wherein the condition is satisfied when the app determines that it is not able to communicate with the server and the app determines that the vehicle is parked.

12. The method of claim 11, further comprising the app triggering the WCD to inform the mobile network that the WCD supports a CE mode as a result of the app determining that the condition is satisfied.

13. The method of claim 12, wherein triggering the WCD to inform the mobile network that the WCD supports a CE mode comprises the app using AT-Command or an application programming interface (API) to send a control plane, CP, message to the WCD.

14. The method of claim 1, further comprising:
determining that the condition is no longer satisfied; and
as a result of determining that the condition is no longer satisfied, informing the mobile network that the WCD does not support any CE mode.

15. The method of claim 1, wherein the WCD is located on or in the vehicle.

16. A wireless communication device (WCD), the WCD comprising:
a transmitter; and
processing circuitry coupled to the transmitter, wherein the WCD is configured to:
employ the transmitter to transmit to a mobile network a capability message indicating that the WCD does not support any CE mode;
determine whether a condition is satisfied by performing a process that includes determining whether a vehicle in which the WCD is equipped is parked; and
as a result of determining that the condition is satisfied, inform the mobile network that the WCD supports a CE mode.

17. The WCD of claim 16, wherein the process further includes determining whether the vehicle is located in an area with poor network coverage.

18. A vehicle comprising the WCD of claim 16.

19. A non-transitory computer readable medium storing computer program comprising instructions which when executed by processing circuitry causes the processing circuitry to perform the method of claim 1.

20. (canceled)
